(19) United States
(12) Patent Application Publication
(10) Pub. No.: US 2025/0167366 A1
(43) Pub. Date: May 22, 2025

(54) CELL SEPARATING ELEMENT FOR ARRANGEMENT BETWEEN TWO BATTERY CELLS AND BATTERY MODULE FOR A MOTOR VEHICLE

(71) Applicant: AUDI AG, Ingolstadt (DE)

(72) Inventors: Dirk HOEFNER, Wellheim (DE); Christian Gert VOIGT, Usingen (DE)

(73) Assignee: AUDI AG, Ingolstadt (DE)

(21) Appl. No.: 18/941,204

(22) Filed: Nov. 8, 2024

(30) Foreign Application Priority Data
Nov. 21, 2023 (DE) 102023132436.5

(51) Int. Cl. H01M 50/242; H01M 10/613; H01M 10/6557; H01M 10/658; H01M 50/291; H01M 50/293

(52) U.S. Cl. CPC H01M 50/242; H01M 10/613; H01M 10/6557; H01M 10/658; H01M 50/291; H01M 50/293

(57) ABSTRACT

A cell separating element for arrangement in an intermediate space between two battery cells of a cell stack arranged adjacent to one another in a stacking direction. The cell separating element has a first flexible outer wall and a second flexible outer wall which are at least partially connected to one another all around at the edges. An interior space of the cell separating element is located between the first and second outer wall. The cell separating element includes an intermediate plate which is arranged between the first and second outer wall, on which at least one first resilient support element is arranged, which resiliently supports the intermediate plate against the first outer wall, and on which at least one second resilient support element is arranged, which resiliently supports the intermediate plate against the second outer wall.

### FIELD

The invention relates to a cell separating element for arrangement in an intermediate space between two battery cells of a cell stack arranged adjacent to one another in a stacking direction, wherein the cell separating element is designed to be elastically compressible at least in part with respect to a first direction which corresponds to the stacking direction when the cell separating element is arranged in the intermediate space, wherein the cell separating element has a first flexible outer wall with a first inner side and a second flexible outer wall with a second inner side, wherein the first and second outer walls are opposite one another in the first direction so that the first inner side faces the second inner side, and wherein the first and second outer walls are at least partially connected to one another all the way around at the edges and wherein an interior space of the cell separating element is located between the first and second outer walls. Furthermore, the invention also relates to a battery module for a motor vehicle.

### BACKGROUND

Battery modules, for example with lithium-ion cells, heat up during the charging and discharging phases. If this temperature reaches a critical value, spontaneous combustion can occur, which is also called propagation. During the charging and discharging phases, the lithium-ion cells also expand, which is called swelling. The battery cells can swell and shrink cyclically. In order to prevent propagation from spreading from one cell to the next, separating plates, usually made of ceramic material, are often used and placed between the cells. However, these plates are usually very stiff and cannot absorb any swelling forces, which can lead to high mechanical stresses within the cell. Furthermore, these separating plates provide very strong thermal insulation, so that almost no heat can be dissipated through them.

It would therefore be desirable to show a way how, on the one hand, heat can be dissipated from the cells as effectively as possible, on the other hand, in the case of propagation, the best possible thermal barrier can be provided between the cells, and, in addition, swelling forces can be absorbed as much as possible during normal operation.

DE 10 2021 121 397 A1 describes an arrangement according to which thermally insulating compression pads, for example made of polyurethane, silicone foam or neoprene-based foam, are arranged between the battery cells.

DE 10 2021 132 874 A1 describes a cell separating element with two contact surfaces and a shape memory material that increases the distance between the contact surfaces when a limit temperature is exceeded.

DE 20 2013 001 662 U1 describes a composite heat distributor for arrangement between battery cells, which comprises a central gas-generating layer and two flexible graphite layers, as well as a protective cover encasing these layers. When a limit temperature is exceeded, the gas-generating layer generates a gas, causing the composite heat distributor to inflate, whereby the composite heat distributor acts as a thermal protection.

EP 4 181 277 A1 describes a metallic cooling fin for arrangement between battery cells, which is designed with a smaller thickness in a central region in order to be better adapted to the swelling geometry of the cells.

In general, the aspects of good heat dissipation during normal operation, good swelling properties and good thermal insulation in the event of thermal runaway of a battery cell are difficult to reconcile when providing a cell separating element.

### SUMMARY

The object of the present invention is therefore to provide a cell separating element and a battery module which make it possible to provide the best possible heat dissipation during normal operation, the best possible thermal insulating properties in the event of thermal runaway of a battery cell and at the same time the best possible swelling compensation.

This object is achieved by a cell separating element and a battery module having the features according to the respective independent claims. Advantageous embodiments of the invention are the subject matter of the dependent claims, the description, and the figures.

A cell separating element according to the invention for arrangement in an intermediate space between two battery cells of a cell stack arranged adjacent to one another in a stacking direction, is designed to be elastically compressible at least in part with respect to a first direction which corresponds to the stacking direction when the cell separating element is arranged in the intermediate space, wherein the cell separating element has a first flexible outer wall with a first inner side and a second flexible outer wall with a second inner side, wherein the first and second outer walls are opposite one another in the first direction so that the first inner side faces the second inner side, wherein the first and second outer walls are at least partially connected to one another all the way around at the edges and wherein an interior space of the cell separating element is located between the first and second outer walls. The cell separating element has an intermediate plate which is arranged between the first and second outer walls, which divides the interior at least into a first spatial region and a second spatial region which are arranged next to one another in the first direction, wherein the intermediate plate comprises a first plate side which faces the first inner side and a second plate side which faces the second inner side, wherein the cell separating element has at least one first resilient support element arranged on the first plate side which resiliently supports the intermediate plate against the first inner side, and at least one second resilient support element arranged on the second plate side which resiliently supports the intermediate plate against the second inner side.

The two flexible outer walls, which can be in direct contact with the adjacent battery cells when arranged in the intermediate space, can provide very good heat dissipation from the battery cells during normal operation. The interior space between the two outer walls can simultaneously provide a good thermal barrier between the two adjacent battery cells. It is now particularly advantageous that an intermediate plate is arranged between the two outer walls, which is resiliently supported relative to the first and second outer walls via the resilient support elements. This allows particularly good swelling properties of the cell separating element to be achieved. Due to the resilient properties of the support elements and the flexible design of the outer walls, the cell separating element is elastically compressible and can therefore absorb swelling forces very well and adapt very well to the swelling geometry of the adjacent battery cells as they swell and shrink. Above all, the intermediate plate and the resilient support by means of the support elements can additionally ensure that a complete flattening of the cell separating element due to high swelling forces can be avoided. In other words, the support elements and the intermediate plate can also ensure that even at high swelling pressures, the internal volume of the cell separating element, namely the volume of the interior of the cell separating element, always has a certain minimum value. This in turn is advantageous on the one hand in order to be able to maintain the thermal barrier that can be provided by the interior space even at high swelling pressures, and on the other hand in the case of an optional liquid cooling system, which will be explained in more detail later but is very advantageous, to ensure that the interior space of the cell separating element can efficiently be passed through even at high swelling forces on the cell separating element, which enables even more efficient heat dissipation. Overall, the aspects of the best possible heat dissipation, the best possible thermal insulation in the event of thermal runaway of a battery cell and particularly good swelling compensation can be combined in an advantageous manner by the cell separating element provided.

The two flexible outer walls can also be called outer shells. These can basically be made of any material, for example a plastic and/or a composite material, in particular a fiber composite plastic, and/or a metallic material or any combination of the materials mentioned. A design of the outer walls made from a metallic material, for example aluminum and/or steel and/or stainless steel, is very advantageous, as this can provide a particularly high thermal conductivity of the flexible outer walls. This has a positive effect on heat dissipation during operation of the cell stack. The outer walls can be provided in the form of outer panels, in particular preformed outer panels with a certain structural rigidity, or also in the form of films, which do not necessarily have to be structurally rigid or dimensionally stable. However, a dimensionally stable design of the outer panels is preferred.

By making the outer walls thin, they can be designed with the desired flexibility to provide the elastically compressible properties. For example, the wall thickness of the respective outer walls, for example with respect to the first direction, can be in the range between 0.1 mm and 0.5 mm, for example approximately 0.25 mm. The two outer walls can be connected to each other at least partially, namely in regions, all around at the edges, in particular connected in a fluid-tight manner. The two outer walls can also be connected to each other all the way around at the edges, in particular connected in a fluid-tight manner, so that the interior is completely enclosed between the two outer walls. In order to enable optional media supply and discharge into and from the interior, the cell separating element can be designed with corresponding supply and discharge connections, as explained in more detail later. In this case, the two outer walls can be connected to each other all the way around at the edges, except for the places where these supply and discharge connections are provided. The two outer walls can, for example, be partially or completely welded together around at the edges and/or joined together in some other way, for example glued and/or pressed and/or crimped or similar.

The intermediate plate, and in particular also the at least one first and second support element, which are also sometimes referred to simply as support elements below, can also in principle be made of any material, for example a metallic material and/or a plastic and/or a composite material and/or any combination thereof. In principle, the intermediate plate, and in particular also the resilient support elements, can be made of a first material which is different from a second material from which the outer walls are made. Such a hybrid structure of the cell separating element enables even more optimization options with regard to heat dissipation and thermal insulation. For example, the outer walls can be made of a metallic material, while the intermediate plate with the support elements is made of a plastic or comprises a plastic. On the one hand, this enables particularly good heat dissipation from the cells and, on the other hand, a good thermal barrier between the two cells arranged adjacent to each other. However, it is particularly advantageous and preferred if the outer walls and the intermediate plate, in particular including the support elements, are made of the same material. This enables a simpler structure and design of the cell separating element and also simplifies joining connections between the individual components, for example by welding. For example, the intermediate plate can also be made of a metallic material, as can the support elements, for example made of aluminum or steel or stainless steel or similar. This also enables a particularly simple and advantageous production of the intermediate plate with the support elements, as will be explained in more detail below.

The outer walls preferably have at least largely or essentially completely flat outer sides. This enables a flat installation on the adjacent battery cell.

The intermediate plate can simply be inserted into the interior. This means that there does not have to be a material connection between the intermediate plate and the two outer walls. However, it is also conceivable that the intermediate plate is materially connected to the two outer walls. For example, it can also be connected at least partially to the two outer walls all the way around at the edges. The two outer walls and the intermediate plate between them can, for example, be welded together all the way around at the edges, for example by means of a common weld seam. Other designs and joint connections between the components are also conceivable.

Furthermore, it is preferred that the intermediate plate extends perpendicular to the first direction over the entire interior space or at least almost the entire interior space. The advantages of the intermediate plate and the support elements arranged on it can thus be advantageously used over the entire surface of the cell separating element. The base surfaces of the outer walls and of the intermediate plate can be aligned and arranged substantially parallel to one another in the uncompressed initial state of the cell separating element. The first spatial region of the interior is located between the first outer wall and the intermediate plate, and the second spatial region of the interior is located between the intermediate plate and the second outer wall. The two spatial regions are preferably substantially equal in terms of their respective volumes, as well as in their dimensions perpendicular to the first direction. Furthermore, it is also preferred that the interior space is divided into only these two spatial regions by the intermediate plate. A division is understood to mean a physical separation of the two spatial regions, at least in some regions, wherein the intermediate plate is arranged in the (imaginary) separating plane between the two spatial regions. However, the two spatial regions can still be fluidically connected. The spatial regions do not have to be completely spatially separated from each other in a fluid-tight manner. This is also particularly less preferred, as explained in more detail later. The division into the first and second spatial regions can therefore only be understood as a theoretical division of the interior into the two spatial regions.

The support elements can, for example, be designed as spring elements. There are numerous possible geometries according to which the support elements can be designed to provide such a resilient effect. For example, the support elements can be designed as spiral springs or leaf springs or similar.

According to a further very advantageous embodiment of the invention, the intermediate plate has at least one through-opening which completely penetrates the intermediate plate in the first direction and via which the first and second spatial regions are fluidically connected to one another, in particular wherein the at least one first support element and/or the at least one second support element directly adjoin at least a part of a spatial region delimiting the through-opening. This design has several particularly great advantages: Firstly, the through-opening, which creates a fluidic connection between the two spatial regions, enables a more efficient flow through the interior of the cell separating element, at least in the event that a coolant is to flow through the cell separating element. This in turn enables a more efficient cooling effect of the cell separating element. But even in the case of a completely closed, non-flow-through design of the cell separating element, this enables a more even pressure distribution within the cell separating element, even if, for example, one of the two outer walls is pressed more strongly towards the intermediate plate than the other outer wall due to cell swelling of the adjacent cell. Furthermore, such a through-opening can result from a particularly advantageous and simple manufacturing method for producing the support elements. As described in more detail below, these can be manufactured, for example, as curved partial cutouts from the intermediate plate. For example, for production a base plate can be provided and a part of the base plate running along a U-shaped contour can first be punched out to produce such a support element. The tab of this base plate, which is enclosed by the punched-out U-shaped contour, can then be bent out of the plate plane of the base plate, for example by means of embossing or other methods, thereby producing a support element. The parts of this base plate that are not bent out then represent the intermediate plate with at least one through-opening. For each support element, for example, a through opening is provided, to which the corresponding support element is adjacent on the side of the edge. The tabs created by the punching described can be bent alternately in opposite directions or bent out of the plate plane, whereby first and second support elements can be provided, which then ultimately support the intermediate plate against the first inner side and the second inner side, in particular support it in a resilient manner.

It is therefore also very advantageous if the intermediate plate including the support elements is made of a metallic material, as this enables a particularly simple production of the support elements by bending or folding over.

According to a further advantageous embodiment, the at least one first support element and/or the at least one second support element are formed integrally with the intermediate plate. This can be easily achieved, for example, using the manufacturing method described above. This also enables particularly fast, simple and cost-effective production of the intermediate plate with the support elements arranged on it. These therefore do not have to be subsequently attached to the intermediate plate, for example by welding or gluing or similar, but can be manufactured, for example, by the manufacturing method described above by punching and folding over together with the intermediate plate from the same starting component, namely the base plate described above.

Therefore a further very advantageous embodiment of the invention is provided in which the intermediate plate lies in a base plane, wherein the at least one first support element and/or the at least one second support element is designed as a punched element bent out of the base plane. In particular, the support elements can be designed as tab-shaped punched elements. In principle however any other geometry is also conceivable. The support elements can be designed as punched elements in such a way that the support elements are each arranged with one end still materially connected to the intermediate plate. A contour surrounding the respective support element except for this connection region can correspond to a punching contour that was punched out of the above-mentioned base plate. The at least one first support element can then be produced by bending it out of the base plane in the first direction and by bending the second support element out of the base plane in a direction opposite to the first direction. The bent-out portions which provide the first and/or second support element can, for example, have a curved shape, namely be arched. This allows a very good spring effect to be provided. In principle, the bent-out punched elements or support elements can be designed with any desired curved shape.

The size and/or number of support elements allows the spring hardness to be adjusted or suitably dimensioned in a particularly simple manner.

According to a further advantageous embodiment of the invention, the cell separating element has a plurality of first resilient support elements arranged on the first plate side, spaced apart from one another and distributed over the first plate side, which form a first support element arrangement, and/or the cell separating element has a plurality of second resilient support elements arranged on the second plate side, spaced apart from one another and distributed over the second plate side, which form a second support element arrangement. By means of such a support element arrangement, a significantly more uniform supporting effect can be achieved compared to the first or second inner side. The resilient effect of this support can thus be provided over the entire surface of the cell separating element perpendicular to the first direction. The respective support elements can be arranged distributed over the respective plate side both in relation to a second direction perpendicular to the first direction and additionally or alternatively also in relation to a third direction which is perpendicular to the first and second directions. A second direction can be defined perpendicular to the first direction, and also a third direction which is also perpendicular to the second direction. The individual first and/or second support elements can be arranged spaced apart and distributed from one another both in the second direction and in the third direction. The support elements of the respective support element arrangements can, for example, be arranged according to a regular pattern.

The first support elements comprise at least one first support element. All other first support elements can be designed in the same way as the at least one first support element or the support elements described above. The plurality of second support elements comprise the at least one second support element. The remaining second support elements can be designed in the same way as already described for the at least one second support element or for the support elements in general.

According to a further advantageous embodiment of the invention, the first and/or second support arrangement is designed such that a first region of the cell separating element has a first spring hardness which is greater than a second spring hardness of a second region of the cell separating element. This has the great advantage that different swelling forces in different regions of the cell separating element can be taken into account. Where the cell separating element is typically subjected to higher swelling forces from the neighboring battery cells, the cell separating element can be designed with a correspondingly higher spring hardness than in other regions. This can be implemented in a particularly simple and advantageous manner by appropriately designing the respective support arrangements. In particular, it can be provided that one or more or all of the first and/or second support elements arranged in a first region of the intermediate plate have a greater spring hardness than at least one or more or all of the first and/or second support elements arranged in a second region of the intermediate plate. The first region of the intermediate plate can correspond to the first region of the cell separating element, and the second region of the intermediate plate can correspond to the second region of the cell separating element. In particular, the first region of the cell separating element can comprise the first region of the intermediate plate and the second region of the cell separating element can comprise the second region of the intermediate plate. The respective regions, i.e. the first region of the cell separating element and the second region of the cell separating element, are arranged next to one another with respect to a direction perpendicular to the first direction. The first region of the intermediate plate and the second region of the intermediate plate are also arranged next to each other perpendicular to the first direction. In a surface perpendicular to the first direction, different spring hardnesses of the cell separating element can thus advantageously be provided. This makes it easy to design the support elements in the respective regions with different spring hardnesses.

Furthermore, it is additionally or alternatively also conceivable that more first and/or more second support elements are arranged per surface unit in a first region of the intermediate plate than in a second region of the intermediate plate. The element density of the support elements can therefore be higher in the first region than in the second region. Even if the support elements are each designed with the same spring hardness, this can easily achieve a higher overall spring hardness in the first region than in the second region. In this example, the first and second regions of the intermediate plate can be defined in the same way as described above. The two embodiments can also be combined with each other as desired. For example, the support elements of a respective identical support element arrangement can have different spring hardnesses and, in addition, the support element density of the respective support element arrangement can also differ or vary in certain regions. This provides numerous advantageous adjustment options. This allows the provision of optimized swelling adjustment.

According to a further advantageous embodiment of the invention, the first region of the cell separating element represents a central region of the cell separating element with respect to at least one second direction perpendicular to the first direction, and the second region of the cell separating element represents an outer region of the cell separating element located outside the central region. This embodiment is based on the finding that the swelling forces in a central region of the cell separating element with respect to at least one second direction perpendicular to the first direction are typically significantly higher than in an edge region of the cell separating element, which is therefore located outside this central region. This design means that the cell separating element is particularly well adapted to the swelling forces that typically occur in a cell stack.

For example, the spring hardness of the cell separating element can be maximum in the central region of the cell separating element with respect to the second direction. The central region of the cell separating element comprises a center of the cell separating element with respect to the second direction. The same can optionally also apply to a third direction, which is defined perpendicular to the first and second directions. For example, the spring hardness of the cell separating element can decrease radially outwards from this central region. The support elements which are arranged next to one another in the second direction can be designed differently, namely they can be designed with a different spring hardness, and/or can have a different distance from one another, wherein also the support elements which are arranged next to one another in the third direction can also be designed differently, namely they can be designed with a different spring hardness, and/or can have a different distance from one another. However, it is also conceivable that the spring hardness decreases from the central region only in and against the second direction towards the outside, but remains constant in and against the third direction towards the outside, for example at least on average. The support elements which are arranged next to one another in the second direction can be designed differently, namely can be designed with a different spring hardness, and/or can have a different distance from one another, wherein the support elements which are arranged next to one another in the third direction can also be designed differently, namely can be designed with a different spring hardness, and/or can have a different distance from one another.

In this case too, it can be provided, for example, that one or more or all of the first and/or second support elements arranged in a central region of the intermediate plate at least with respect to the second direction have a greater spring hardness than at least one or more or all of the first and/or second support elements arranged outside the central region of the intermediate plate at least with respect to the second direction. Additionally or alternatively, it can be provided that more first and/or second support elements are arranged per unit area in a region of the intermediate plate that is central at least with respect to the second direction than in a region of the intermediate plate that is arranged outside the central region of the intermediate plate at least with respect to the second direction. These embodiments may apply not only with respect to the second direction, but optionally additionally or alternatively also with respect to the third direction defined above.

According to a further advantageous embodiment of the invention, the cell separating element has at least one coolant supply connection for supplying a coolant into the interior and at least one coolant discharge connection for discharging the coolant from the interior. As a result, the cell separating element can be designed such that a coolant, in particular a gaseous and/or liquid coolant, preferably a liquid coolant, can flow through it. In this case, the two outer walls are connected to each other at the edges in such a way that this connection is fluid-tight. This allows the cell separating element to provide an even more efficient cooling effect. When the cell separating element is used in a battery or in a motor vehicle, such a coolant flows through the cell separating element during cooling operation. Such a coolant can be circulated in a cooling circuit of the motor vehicle. The cell separating element is connected accordingly to this cooling circuit. The cell separating element can have only one coolant supply connection and a coolant discharge connection, for example. These can, for example, be arranged on the same side with respect to the second or third direction of the cell separating element. This allows the provision of a U-shaped flow through the cell separating element. However, the two connections can also be arranged on opposite sides of the cell separating element with respect to the second direction or with respect to the third direction. This allows flow through the cell separating element from one side to the opposite side. This flow can also be Z-shaped, depending on how the coolant is routed in the interior. The support elements can also serve as flow guide elements in the interior. This allows specific flow conditions to be set and the coolant flowing through the interior to be directed or guided in a targeted manner.

Furthermore, it is conceivable that the cell separating element comprises two coolant supply connections and two coolant discharge connections. Two of these four connections are arranged on one side of the cell separating element and the other two of the four connections are arranged on the opposite side of the cell separating element. This can again refer to the second or third direction. For example, two supply connections can be arranged on the same one side and two discharge connections on the same other side. However, a supply connection and a discharge connection can also be arranged on the same side. The design with two supply and discharge connections allows more flexibility with regard to the flow options of the cell separating element.

According to a further advantageous embodiment of the invention, the interior space between the first and second outer walls is connected in a fluid-tight manner, in particular wherein a gaseous and/or liquid cooling medium is arranged in the interior space. In this case, the interior space of the cell separating element should not be designed to allow a flow through it, or at least not by a coolant that is supplied externally and then discharged externally. This allows a simpler design of the cell separating element. If this is additionally filled with a cooling medium, for example a gaseous and/or liquid cooling medium, additional advantageous properties of the cell separating element can be implemented. For example, if the interior remains filled with air, this can provide a particularly good thermal barrier of the cell separating element between the two adjacent cells. If the cell separating element is filled with a liquid cooling medium, such as water or oil or similar, the high heat capacity can provide both a good thermal insulating effect and good heat absorption through the cell separating element. The interior may also contain a phase change material or something similar. In general, the cell separating element can also function as a heat pipe.

Furthermore, in this case it is preferred that the cell separating element is thermally and/or physically connected to a corresponding heat sink when installed in a battery module. This allows for particularly efficient heat dissipation from the battery cells via the cell separating element to this heat sink. Such a heat sink can be provided, for example, in the form of a cooling plate through which a coolant can flow, which can also be referred to as a cooler. The cell stack can, for example, be placed on such a cooling plate. In addition, the cell stack can be connected to the cooling plate via a thermal interface material, for example a thermally conductive compound, in particular a curable thermally conductive compound. The thermally conductive compound can also be used to establish thermal and indirect physical contact between the cell separating element and the cooling plate.

According to a further advantageous embodiment of the invention, the cell separating element has at least one layer, in particular in the form of a fabric and/or fiber board, which is arranged in the first and/or second spatial region. Such a layer is preferably also compressible with respect to the first direction, in particular elastically compressible. By means of such an additional layer or optionally also two such additional layers, which can be arranged, for example, in the respective spatial regions of the interior, further advantageous properties of the cell separating element can be realized. The layer can also have a plate-like shape. In addition, this layer can extend perpendicular to the first direction over the entire interior space or spatial region in which it is arranged. For example, this layer can further improve the propagation behavior. Such a layer may, for example, comprise glass fibers and/or aramid fibers and/or ceramic fibers or other fibers. Such fibers are particularly temperature stable and create an additional barrier between the cells in case of propagation. The support elements can penetrate such a layer in the first direction or such a layer can lie directly against an inner side of the outer walls and the support elements can rest against this.

Furthermore, the invention also relates to a battery module for a motor vehicle, wherein the battery module comprises a cell separating element according to the invention or one of its embodiments.

The battery module can in particular comprise a cell stack with a plurality of battery cells arranged next to one another in a stacking direction. The battery cells can be formed as lithium-ion cells, for example. The battery cells can in particular be prismatic battery cells or pouch cells, for example. The cell stack can be clamped in the stacking direction by means of a clamping device. A cell separating element according to the invention or a cell separating element according to an exemplary embodiment of the invention can be arranged between each two battery cells of the cell stack arranged adjacent to one another. If the cell separating elements are designed so that a coolant can flow through them, the cell separating elements can be connected to a common coolant supply line and/or a common coolant discharge line, in particular via the coolant supply and/or discharge connections already described above. The cell separating element or the cell separating elements can be limited in terms of their extent or their dimensions perpendicular to the first direction to the space between two battery cells of the cell stack arranged adjacent to one another. The optional coolant supply and discharge connections can protrude from such a intermediate space. A corresponding coolant supply and/or discharge line is preferably arranged outside the respective intermediate spaces between two respective battery cells arranged adjacent to one another. The two flexible outer walls of each cell separating element preferably lie flat against the adjacent battery cells of the cell stack. The outer walls can correspond in terms of their outer surface to the surfaces of the cell housing sides of the battery cells to which they are adjacent. The outer walls can also be slightly smaller than the respective cell housing surfaces of the adjacent battery cells. Preferably, the cell separating element is in flat contact with the adjacent battery cells. The cell separating element can also be glued to the adjacent battery cells or at least one of the adjacent battery cells. However, the cell separating element does not necessarily have to have a material connection to one or more of the adjacent battery cells. This simplifies the dismantling of the battery module, for example in the event of repairs.

Furthermore, the invention also relates to a battery having a battery module according to the invention or one of its embodiments. Such a battery can also comprise a plurality of such battery modules. The battery can be designed, for example, as a high-voltage battery.

The battery may also comprise the above-mentioned heat sink, for example in the form of a cooling plate. The cooling plate can be provided, for example, by a housing base of a battery housing and/or by a housing cover of such a battery housing.

Moreover, the invention also relates to a motor vehicle having a battery module according to the invention or one of its embodiments or having a battery according to the invention or one of its embodiments.

The motor vehicle may be designed as an electric vehicle, for example. The battery can function as a traction battery for the motor vehicle, for example.

The motor vehicle according to the invention is preferably designed as an automobile, in particular as a passenger car or truck, or as a passenger bus or motorcycle.

The invention also includes further developments of the battery according to the invention, the battery module according to the invention and the motor vehicle according to the invention, which have features as already described in connection with the further developments of the cell separating element according to the invention. For this reason, the corresponding developments of the battery according to the invention, of the battery module according to the invention and of the motor vehicle according to the invention are not described again here.

The invention also comprises the combinations of the features of the described embodiments. The invention therefore also comprises implementations which each have a combination of the features of several of the described embodiments, unless the embodiments have been described as mutually exclusive.

### BRIEF DESCRIPTION OF THE FIGURES

Exemplary embodiments of the invention are described hereinafter. In particular:

FIG. 1 shows a schematic and perspective exploded representation of a cell separating element according to an exemplary embodiment of the invention;

FIG. 2 shows a schematic and perspective representation of the cell separating element from FIG. 1 according to an exemplary embodiment of the invention;

FIG. 3 shows a schematic representation of a battery module with two battery cells and a cell separating element arranged therebetween in a sectional representation according to an exemplary embodiment of the invention;

FIG. 4 shows a schematic representation of a battery module with two battery cells and a cell separating element arranged therebetween in a non-swollen initial state of the battery cells according to an exemplary embodiment of the invention; and

FIG. 5 shows a schematic representation of a battery module of FIG. 4 in a swollen state of the battery cells according to an exemplary embodiment of the invention.

### DETAILED DESCRIPTION

The exemplary embodiments explained below are preferred embodiments of the invention. In the exemplary embodiments, the described components of the embodiments each represent individual features of the invention to be considered independently of one another, which each also develop the invention independently of one another. Therefore, the disclosure is also predetermined to comprise combinations of the features of the embodiments other than those represented. Furthermore, the described embodiments can also be supplemented by further ones of the above-described features of the invention.

In the figures, same reference numerals respectively designate elements that have the same function.

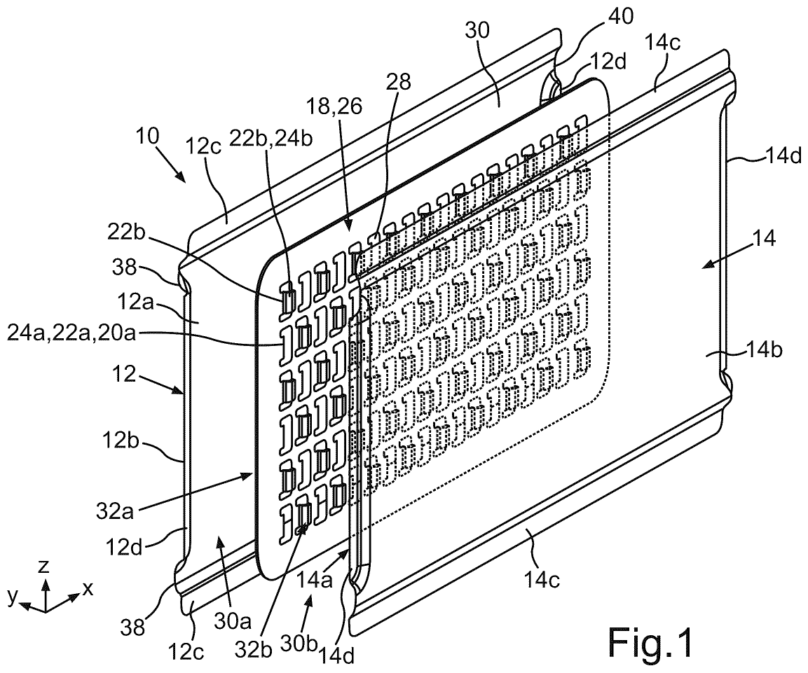

The coordinate systems shown in FIG. 1 to FIG. 5 are Cartesian coordinate systems. The y-direction shown preferably corresponds to the first direction mentioned above. The x direction shown can correspond to the above mentioned second or third direction mentioned and the z-direction shown can correspondingly correspond to above mentioned third or second direction.

FIG. 1 shows a schematic and perspective exploded representation of a cell separating element 10 according to an exemplary embodiment of the invention. The cell separating element 10 has a first flexible outer wall 12 and a second flexible outer wall 14. The first outer wall 12 comprises a first inner side 12a and a first outer side 12b, which is opposite the inner side 12a, in particular with respect to the y-direction shown here, which corresponds to a stacking direction of the arrangement of the cell separating element 10 in a cell stack 16 (see FIG. 3). The second outer wall 14 also comprises a second inner side 14a (see also FIG. 3) and a second outer side 14b opposite thereto with respect to the y-direction. The outer walls 12, 14 are designed to be flexible, for example as thin-walled preformed plates, for example made of a metallic material.

In addition, the cell separating element 10 comprises an intermediate plate 18 and resilient support elements 20a, 20b arranged on the intermediate plate. In general, the cell separating element 10 comprises at least one first support element 20a, which supports the first inner side 12a against the intermediate plate 18 in the assembled state of the cell separating element 10, in particular supports it resiliently, and at least one second support element 20b, which supports the second inner side 14a against the intermediate plate 18 in the assembled state of the cell separating element 10. For this purpose, the support elements 20a, 20b can directly contact the respective inner sides 12a, 14a. In the present example, the cell separating element 10 comprises multiple first and second support elements 20a, 20b. Each of these support elements 20a, 20b comprises a connection region 22a, 22b, via which the corresponding support element 20a, 20b is connected in contact with the plate 18. In particular, the plate 18 and the support elements 20a, 20b are formed in one piece in this example. In particular, the support elements 20a, 20b are designed as punched elements 24a, 24b. These can be provided by punching out the respective support elements 20a, 20b along a circumferential contour from a base plate 26, except in the region of their connection regions 22a, 22b, and then the remaining tabs can be bent out of the base plane of the base plate 26 in or against the y-direction to form the support elements 20a, 20b. The first support elements 20a thus protrude from the intermediate plate 18 in the y-direction, while the second support elements 20b protrude from the intermediate plate 18 against the y-direction. Of the first support elements 20a, only the connection region 22a can be seen in the present illustration. The respective support elements 20a, 20b can be curved in their course from the connection region 22a, 22b to a respective opposite free end of the respective support element 20a, 20b. This advantageously allows a resilient property of the support elements 20a, 20b to be implemented.

In addition, the intermediate plate 18 comprises at least one through-opening 28 penetrating it, and in the present example one such through-opening 28 per support element 20a, 20b. This can be automatically generated during the manufacture or formation of the support elements 20a, 20b from the base plate 26.

The intermediate plate 18 can be designed together with the support elements 20a, 20b as an insert component which will be or is inserted into the space between the outer walls 12, 14, which enclose or surround an interior space 30 of the cell separating element 10 in the assembled state of the cell separating element 10. Optionally, the intermediate plate 18 can also be joined to the outer walls 12, 14, in particular joined in a material-connecting manner, for example welded to them.

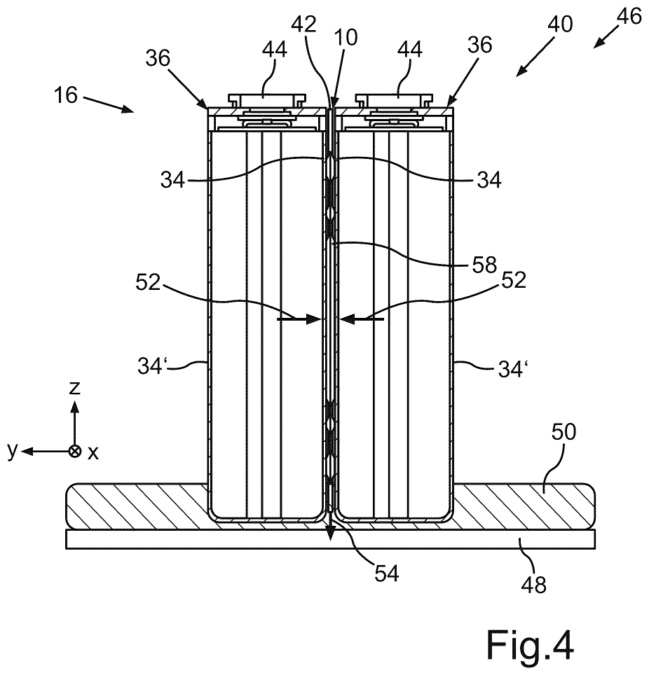

The first support elements 20a accordingly form a first support element arrangement 32a and the second support elements 20b form a second support element arrangement 32b. According to these support arrangements 32a, 32b, the first and second support elements 20a, 20b are arranged in rows and columns in both the x-direction and the z-direction next to each other and spaced from each other according to a regular pattern. Other configurations are also conceivable. The respective outer sides 12b, 14b of the outer walls 12, 14 can essentially correspond in terms of geometry and size to the mutually facing housing sides 34 (see FIG. 3 and FIG. 4) of the adjacent battery cells 36 (see FIG. 3 and FIG. 4) of the cell stack 16 (see FIG. 3 and FIG. 4). Optionally, the outer sides 12b, 14b can be designed slightly smaller than the corresponding cell sides 34. The intermediate plate 18 can also correspond in size and/or geometry to the size or geometry of the corresponding inner sides 12a, 14a of the outer walls 12, 14 or be slightly smaller. The cell separating element 10 is essentially of rectangular design. The respective support element arrangements 32a, 32b extend in the x- and z-direction over a large part and preferably over almost all of intermediate plate 18 in the x- and z-direction.

Due to the intermediate plate 18, the interior space 30 in the assembled state of the cell separating element 10 is divided into a first spatial region 30a and a second spatial region 30b. The respective support elements 20a, 20b then rest accordingly on the respective inner sides 12a, 14a of the outer walls 12, 14, contacting with their free ends.

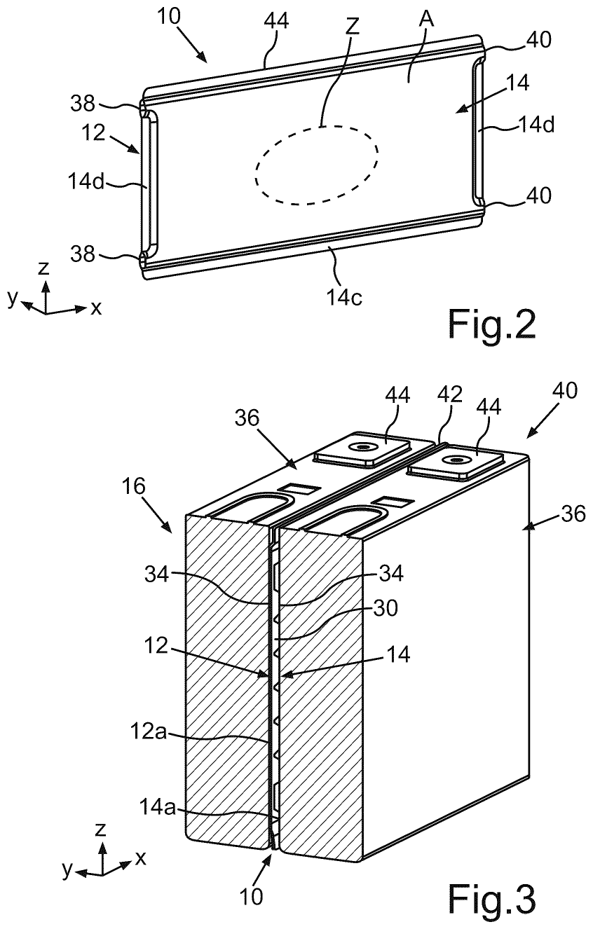

The first outer wall 12 has two edge regions 12c opposite each other in the z-direction and two edge regions 12d opposite each other in the x-direction. The first outer wall 14 has two edge regions 14c opposite each other in the z-direction and two edge regions 14d opposite each other in the x-direction. In the assembled state of the cell separating element 10, the two outer walls 12, 14 are connected to each other via these edge regions 12c, 12d, 14c, 14d. In particular, the two outer walls are at least partially connected to each other all the way around at the edges, in particular joined together in a fluid-tight manner. In the present example, the cell separating element 10 has four optional connections 38, 40 (see also FIG. 2). Two of these four connections 38, 40 can function as coolant supply connections and the other two as coolant discharge connections. For example, the connections 38 can be designed as coolant supply connections and the two connections 40 as coolant discharge connections or vice versa. One of the connections 38 and one of the connections 40 can also be coolant supply connections and the remaining two connections 38, 40 can be coolant discharge connections.

This advantageously makes it possible to supply a coolant to the interior 30 and to discharge it again from there. The interior space 30 is thus designed to be passed through by a flow. The outer walls 12, 14 can be joined together in a fluid-tight manner in the edge region except for these connection regions 38, 40, for example by being welded together. The openings 28 in the intermediate plate 18 also enable a flow between the two spatial regions 30a, 30b of the interior 30. The support elements 20a, 20b provide particularly advantageous swelling compensation properties. In addition, they also ensure that the outer walls 12, 14 always have a certain distance from each other and that the interior space 30 therefore always has a certain minimum volume. This ensures that the coolant can flow reliably through the interior space 30 even in the event of significant swelling of the battery cells 36 and/or that a thermal barrier is reliably maintained.

FIG. 2 shows a schematic and perspective representation of the cell separating element 10 from FIG. 1 in the assembled state. The connections 38, 40 are only optional in this case. The outer walls 12, 14 of the cell separating element 10 can also be joined together in a fluid-tight manner all the way around at the edge region. For example, a cooling medium can then be enclosed in the interior space 30, for example a gaseous and/or liquid cooling medium based on standard conditions, namely at a temperature of 0° C. and a pressure of 1013.25 mbar, or a phase change material.

FIG. 3 shows a schematic representation of a cell stack 16 as part of a battery module 40, with two exemplary battery cells 36 shown. In this example, these are designed as prismatic battery cells 36. In the space 42 between these battery cells 36 there is a cell separating element 10 according to an exemplary embodiment of the invention. The cell separating element 10 can be designed as previously described, although not shown in such detail here. The cell stack 16 is illustrated in a sectional view. Each cell 36 also has two cell poles 44, of which only one respective cell pole is visible in this illustration. In addition, each cell 36 has two cell poles 44, of which only one is visible in the present illustration. The two outer sides 12b, 14b of the outer walls 12, 14 lie flat against the cell sides 34 facing inwards.

FIG. 4 shows a schematic representation of a battery module 40 according to a further exemplary embodiment of the invention. The battery module 40 can essentially be designed as described above. This also comprises, by way of example, a cell stack 16 with two battery cells 36. Such a cell stack 16 can generally comprise any number of cells 36, wherein such a cell separating element 10 is then preferably arranged between each two battery cells 36 arranged next to one another in the stacking direction y. The battery module 40 can be part of a battery 46. Such a battery 46 can comprise multiple battery modules 40. In addition, FIG. 4 also shows a cooler 48, for example in the form of a cooling plate 48, through which a coolant can flow, in particular through which a liquid coolant can flow and through which a liquid coolant flows during operation. This cooler 48 can be part of the battery 46. Multiple battery modules 40 can be arranged on the same cooler 48. The cooler 48 can also be part of the battery module 40. Each battery module 40 of the battery 46 may, for example, comprise a separate cooler. The cell stack 16 is connected to the cooler 48 via a thermal interface material, for example a thermal paste 50. This applies in particular also to the cell separating element 10 arranged between the cells 36. In the present case, the cooler 48 is arranged below the cell stack 16 with respect to the z-direction. The cooler 48 is generally arranged on any outer side of the cell stack 16. The cooler can additionally or alternatively be arranged above the cell stack 16 with respect to the z-direction and/or in front of or behind the cell stack 16 with respect to the x-direction. Multiple coolers 48 can also be provided, which can be arranged on different outer sides of the cell stack 16. This advantageously provides a heat conduction path from the battery cells 16 via the cell separating element 10 and the thermal paste 50 to the cooler 48. The cooler 48 acts as a heat sink in a cooling mode for cooling the cells 36. Conversely, the cells 36 can also optionally be heated in this way. Accordingly, in a heating operating mode, heat can also be transferred via the cooler 48 via the thermal paste 50 to the cell separating element 10 and from there to the cells 36.

The heat input from the cells 36 into the cell separating element 10 in a cooling operation is illustrated by the arrows 52 and the corresponding heat transfer from the cell separating element 10 via the thermal paste 50 to the cooler 48 by the arrow 54. As a result, heat dissipation via the thermal paste 50 into the cooler 48 can advantageously be provided in cooling operation.

In this example, the cell separating element 10 is not designed to allow a coolant to flow through, but rather with an interior space 30 that is completely enclosed by the outer walls 12, 14. This interior space can be filled with air, for example. The air filling then acts as an insulating air layer 58. This is particularly advantageous in the case of propagation. Due to the direct contact of the cell sides 34 with the outer walls 12, 14 of the cell separating element 10, very good heat dissipation to the cooler 48 can be provided despite this insulating air layer 58.

Instead of an air layer 58, the interior space 30 can also be filled with another cooling medium, for example water.

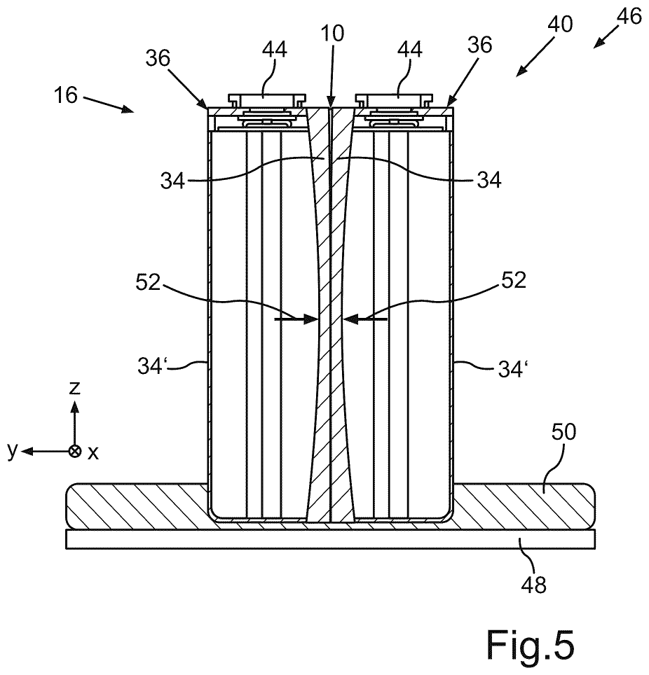

In addition, FIG. 4 shows the battery cells 36 in a non-swollen initial state. FIG. 5 shows a schematic representation of the battery module 40 or the battery 46 from FIG. 4 in a state in which the battery cells 36 are swollen in and against the y-direction, wherein this swelling is illustrated by way of example only for the two cell sides 34 facing each other, and can, however, be formed analogously on the opposite cell sides 34′. The intermediate plate 18 described above (see FIG. 1) with the support elements 20a, 20b arranged thereon (see FIG. 1) enables a particularly advantageous swelling compensation. In particular, the respective support arrangements 32a, 32b (see FIG. 1) can be designed such that different regions of the cell separating element 10 have different spring hardnesses. For such swelling compensation, it is advantageous, for example, to have a higher spring hardness in a central region Z, which is illustrated by way of example by a dashed line in FIG. 2, than in an outer region A (see FIG. 2), which is arranged outside the central region Z and/or next to this central region Z with respect to the x and/or z direction. This can be easily achieved by using a different support element density and/or different spring hardnesses of the individual support elements 20a, 20b.

Overall, the examples show how the invention can provide a cell separating element with a cooling function and variable compression behavior. By means of a separating plate, primarily made of steel, cell propagation can be safely prevented and at the same time swelling forces can be absorbed and heat can be dissipated from the cell. This separating plate was previously also called a cell separating element. This is achieved by a separating plate, primarily made of steel, which is composed as a membrane of at least two layers, for example the previously mentioned outer walls. The membrane can be filled with or flowed through by various gases or fluids, which allows two properties, namely spring stiffness and insulation quality, to be adjusted. By means of an insert, which was previously also referred to as an intermediate plate with support elements, primarily made of steel, different stiffnesses and/or spring hardnesses can be reproduced with various ribbing and/or embossings, which can be provided by the support elements described above. By inserting an additional layer, for example a fabric and/or fiber board, between the two metal layers, namely the outer walls, the propagation behavior can be further improved.

1. A cell separating element for arrangement in an intermediate space between two battery cells of a cell stack which are arranged adjacent to one another in a stacking direction,
wherein the cell separating element is designed to be elastically compressible at least in part with respect to a first direction, which corresponds to the stacking direction when the cell separating element is arranged in the intermediate space,
wherein the cell separating element has a first flexible outer wall with a first inner side and a second flexible outer wall with a second inner side,
wherein the first and second outer wall are opposite each other in the first direction, so that the first inner side faces the second inner side,
wherein the first and second outer walls are at least partially connected to one another all around at the edges and wherein an interior space of the cell separating element is located between the first and second outer wall;
wherein the cell separating element has an intermediate plate which is arranged between the first and second outer wall, which divides the interior space into at least a first spatial region and a second spatial region, which are arranged next to one another in the first direction,
wherein the intermediate plate comprises a first plate side facing the first inner side and a second plate side facing the second inner side,
wherein the cell separating element has at least one first resilient support element arranged on the first plate side, which resiliently supports the intermediate plate against the first inner side, and at least one second resilient support element arranged on the second plate side, which resiliently supports the intermediate plate against the second inner side.

2. The cell separating element according to claim 1, wherein the intermediate plate has at least one through-opening which completely penetrates the intermediate plate in the first direction, via which through-opening the first and second spatial regions are fluidically connected to one another, in particular wherein the at least one first support element and/or the at least one second support element directly adjoin at least part of an edge region delimiting the through-opening.

3. The cell separating element according to claim 1, wherein the intermediate plate lies in a base plane, wherein the at least one first support element and/or the at least one second support element are designed as a punched element bent out of the base plane.

4. The cell separating element according to claim 1, wherein the cell separating element has multiple first resilient support elements arranged on the first plate side, spaced apart from one another and distributed over the first plate side, which form a first support element arrangement, and/or the cell separating element has multiple second resilient support elements arranged on the second plate side, spaced apart from one another and distributed over the second plate side, which form a second support element arrangement.

5. The cell separating element according to claim 1, wherein the first and/or second support arrangement are designed such that a first region of the cell separating element has a first spring hardness which is greater than a second spring hardness of a second region of the cell separating element,
wherein one or more or all of the first and/or second support elements arranged in a first region of the intermediate plate have a greater spring hardness than at least one or more or all of the first and/or second support elements arranged in a second region of the intermediate plate; and/or
in a first region of the intermediate plate more first and/or second support elements are arranged per unit area than in a second region of the intermediate plate.

6. The cell separating element according to claim 1, wherein the first region of the cell separating element represents a central region of the cell separating element with respect to at least one second direction perpendicular to the first direction, and the second region of the cell separating element represents an outer region of the cell separating element located outside the central region.

7. The cell separating element according to claim 1, wherein the cell separating element has at least one coolant supply connection for supplying a coolant into the interior space and at least one coolant discharge connection for discharging the coolant from the interior space.

8. The cell separating element according to claim 1, wherein the interior space is enclosed in a fluid-tight manner between the first and second outer wall, in particular wherein a gaseous and/or liquid cooling medium is arranged in the interior space.

9. The cell separating element according to claim 1, wherein the cell separating element has at least one layer, in particular in the form of a fabric and/or fiber plate, which is arranged in the first and/or second spatial region.

10. A battery module for a motor vehicle with a cell separating element according to claim 1.

11. The cell separating element according to claim 2, wherein the intermediate plate lies in a base plane, wherein the at least one first support element and/or the at least one second support element are designed as a punched element bent out of the base plane.

12. The cell separating element according to claim 2, wherein the cell separating element has multiple first resilient support elements arranged on the first plate side, spaced apart from one another and distributed over the first plate side, which form a first support element arrangement, and/or the cell separating element has multiple second resilient support elements arranged on the second plate side, spaced apart from one another and distributed over the second plate side, which form a second support element arrangement.

13. The cell separating element according to claim 3, wherein the cell separating element has multiple first resilient support elements arranged on the first plate side, spaced apart from one another and distributed over the first plate side, which form a first support element arrangement, and/or the cell separating element has multiple second resilient support elements arranged on the second plate side, spaced apart from one another and distributed over the second plate side, which form a second support element arrangement.

14. The cell separating element according to claim 2, wherein the first and/or second support arrangement are designed such that a first region of the cell separating element has a first spring hardness which is greater than a second spring hardness of a second region of the cell separating element,
wherein one or more or all of the first and/or second support elements arranged in a first region of the intermediate plate have a greater spring hardness than at least one or more or all of the first and/or second support elements arranged in a second region of the intermediate plate; and/or
in a first region of the intermediate plate more first and/or second support elements are arranged per unit area than in a second region of the intermediate plate.

15. The cell separating element according to claim 3, wherein the first and/or second support arrangement are designed such that a first region of the cell separating element has a first spring hardness which is greater than a second spring hardness of a second region of the cell separating element,
wherein one or more or all of the first and/or second support elements arranged in a first region of the intermediate plate have a greater spring hardness than at least one or more or all of the first and/or second support elements arranged in a second region of the intermediate plate; and/or
in a first region of the intermediate plate more first and/or second support elements are arranged per unit area than in a second region of the intermediate plate.

16. The cell separating element according to claim 4, wherein the first and/or second support arrangement are designed such that a first region of the cell separating element has a first spring hardness which is greater than a second spring hardness of a second region of the cell separating element,
wherein one or more or all of the first and/or second support elements arranged in a first region of the intermediate plate have a greater spring hardness than at least one or more or all of the first and/or second support elements arranged in a second region of the intermediate plate; and/or
in a first region of the intermediate plate more first and/or second support elements are arranged per unit area than in a second region of the intermediate plate.

17. The cell separating element according to claim 2, wherein the first region of the cell separating element represents a central region of the cell separating element with respect to at least one second direction perpendicular to the first direction, and the second region of the cell separating element represents an outer region of the cell separating element located outside the central region.

18. The cell separating element according to claim 3, wherein the first region of the cell separating element represents a central region of the cell separating element with respect to at least one second direction perpendicular to the first direction, and the second region of the cell separating element represents an outer region of the cell separating element located outside the central region.

19. The cell separating element according to claim 4, wherein the first region of the cell separating element represents a central region of the cell separating element with respect to at least one second direction perpendicular to the first direction, and the second region of the cell separating element represents an outer region of the cell separating element located outside the central region.

20. The cell separating element according to claim 5, wherein the first region of the cell separating element represents a central region of the cell separating element with respect to at least one second direction perpendicular to the first direction, and the second region of the cell separating element represents an outer region of the cell separating element located outside the central region.
